(19) United States
(12) Patent Application Publication
(10) Pub. No.: US 2006/0229854 A1
(43) Pub. Date: Oct. 12, 2006

(54) Computer system architecture for probabilistic modeling

(75) Inventors: Anthony J. Grichnik, Peoria, IL (US); Michael Seskin, Cardiff, CA (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/192,360

(22) Filed: Jul. 29, 2005

Related U.S. Application Data
(60) Provisional application No. 60/669,351, filed on Apr. 8, 2005.

(51) Int. Cl. G06F 17/10

(52) U.S. Cl. 703/2

(57) ABSTRACT

A computer system for probabilistic modeling includes a display and one or more input devices. A processor may be configured to execute instructions for generating at least one view representative of a probabilistic model and providing the at least one view to the display. The instructions may also include receiving data through the one or more input devices, running a simulation of the probabilistic model based on the data, and generating a model output including a predicted probability distribution associated with each of one or more output parameters of the probabilistic model. The model output may be provided to the display.

### CROSS REFERENCE

This application is based upon and claims the benefit of priority from U.S. Provisional Application No. 60/669,351 to Grichnik et al. filed on Apr. 8, 2005, the entire contents of which are incorporated herein by reference

### TECHNICAL FIELD

This disclosure relates generally to computer based systems and, more particularly, to computer based system and architecture for probabilistic modeling.

### BACKGROUND

Many computer-based applications exist for aiding various computer modeling pursuits. For example, using these applications, an engineer can construct a computer model of a particular product, component, or system and can analyze the behavior of each through various analysis techniques. Often, these computer-based applications accept a particular set of numerical values as model input parameters. Based on the selected input parameter values, the model can return an output representative of a performance characteristic associated with the product, component, or system being modeled. While this information can be helpful to the designer, these computer-based modeling applications fail to provide additional knowledge regarding the interrelationships between the input parameters to the model and the output parameters. Further, the output generated by these applications is typically in the form of a non-probabilistic set of output values generated based on the values of the supplied input parameters. That is, no probability distribution information associated with the values for the output parameters is supplied to the designer.

One such application is described, for example, by U.S. Pat. No. 6,086,617 (“the '617 patent”) issued to Waldon et al. on Jul. 11, 2000. The '617 patent describes an optimization design application that includes a directed heuristic search (DHS). The DHS directs a design optimization process that implements a user's selections and directions. The DHS also directs the order and directions in which the search for an optimal design is conducted and how the search sequences through potential design solutions. Ultimately, the system of the '617 patent returns a particular set of output values as a result of its optimization process.

While the optimization design system of the '617 patent may provide a multi-disciplinary solution for design optimization, this system has several shortcomings. In this system, there is no knowledge in the model of how variation in the input parameters relates to variation in the output parameters. The system of the '617 patent provides only single point, non-probabilistic solutions, which may be inadequate, especially where a single point optimum may be unstable when subject to variability introduced by a manufacturing process or other sources.

The lack of probabilistic information being supplied with a model output can detract from the analytical value of the output. For example, while a designer may be able to evaluate a particular set of output values with respect to a known compliance state for the product, component, or system, this set of values will not convey to the designer how the output values depend on the values, or ranges of values, of the input parameters. Additionally, the output will not include any information regarding the probability of compliance with the compliance state.

The disclosed systems are directed to solving one or more of the problems set forth above.

### SUMMARY OF THE INVENTION

One aspect of the present disclosure includes a computer system for probabilistic modeling. This system may include a display and one or more input devices. A processor may be configured to execute instructions for generating at least one view representative of a probabilistic model and providing the at least one view to the display. The instructions may also include receiving data through the one or more input devices, running a simulation of the probabilistic model based on the data, and generating a model output including a predicted probability distribution associated with each of one or more output parameters of the probabilistic model. The model output may be provided to the display.

Another aspect of the present disclosure includes a computer system for building a probabilistic model. The system includes at least one database, a display, and a processor. The processor may be configured to execute instructions for obtaining, from the at least one database, data records relating to one or more input variables and one or more output parameters. The processor may also be configured to execute instructions for selecting one or more input parameters from the one or more input variables and generating, based on the data records, the probabilistic model indicative of interrelationships between the one or more input parameters and the one or more output parameters, wherein the probabilistic model is configured to generate statistical distributions for the one or more input parameters and the one or more output parameters, based on a set of model constraints. At least one view, representative of the probabilistic model, may be displayed on the display.

Yet another aspect of the present disclosure includes a computer readable medium including instructions for displaying at least one view representative of a probabilistic model, wherein the probabilistic model is configured to represent interrelationships between one or more input parameters and one or more output parameters and to generate statistical distributions for the one or more input parameters and the one or more output parameters, based on a set of model constraints. The medium may also include instructions for receiving data through at least one input device, running a simulation of the probabilistic model based on the data, and generating a model output including a predicted probability distribution associated with each of the one or more output parameters. The model output may be provided to a display.

### BRIEF DESCRIPTION OF THE DRAWINGS

FIG. 1 is block diagram representation of a computer system according to an exemplary disclosed embodiment.

FIG. 2 is a block diagram representation of an exemplary computer architecture consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

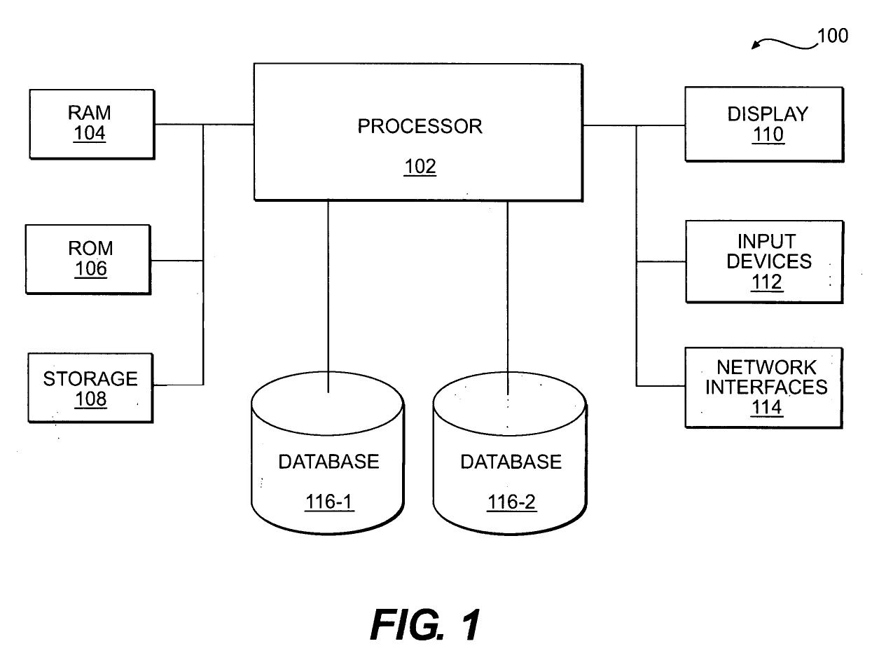

FIG. 1 provides a block diagram representation of a computer-based probabilistic modeling system 100. Modeling system 100 may include a processor 102, random access memory (RAM) 104, a read-only memory 106, a storage 108, a display 110, input devices 112, and a network interface 114. Modeling system 100 may also include a databases 116-1 and 116-2. Any other components suitable for receiving and interacting with data, executing instructions, communicating with one or more external workstations, displaying information, etc. may also be included in modeling system 100.

Processor 102 may include any appropriate type of general purpose microprocessor, digital signal processor or microcontroller. Processor 102 may execute sequences of computer program instructions to perform various processes associated with modeling system 100. The computer program instructions may be loaded into RAM 104 for execution by processor 102 from read-only memory 106, or from storage 108. Storage 108 may include any appropriate type of mass storage provided to store any type of information that processor 102 may need to perform the processes. For example, storage 108 may include one or more hard disk devices, optical disk devices, or other storage devices to provide storage space.

Display 110 may provide information to users of modeling system 100 via a graphical user interface (GUI). Display 110 may include any appropriate type of computer display device or computer monitor (e.g., CRT or LCD based monitor devices). Input devices 112 may be provided for users to input information into modeling system 100. Input devices 112 may include, for example, a keyboard, a mouse, an electronic tablet, voice communication devices, or any other optical or wireless computer input devices. Network interfaces 114 may provide communication connections such that modeling system 100 may be accessed remotely through computer networks via various communication protocols, such as transmission control protocol/internet protocol (TCP/IP), hyper text transfer protocol (HTTP), etc.

Databases 116-1 and 116-2 may contain model data and any information related to data records under analysis, such as training and testing data. Databases 116-1 and 116-2 may also contain any stored versions of pre-built models or files associated with operation of those models. Databases 116-1 and 116-2 may include any type of commercial or customized databases. Databases 116-1 and 116-2 may also include analysis tools for analyzing the information in the databases. Processor 102 may also use databases 116-1 and 116-2 to determine and store performance characteristics related to the operation of modeling system 100.

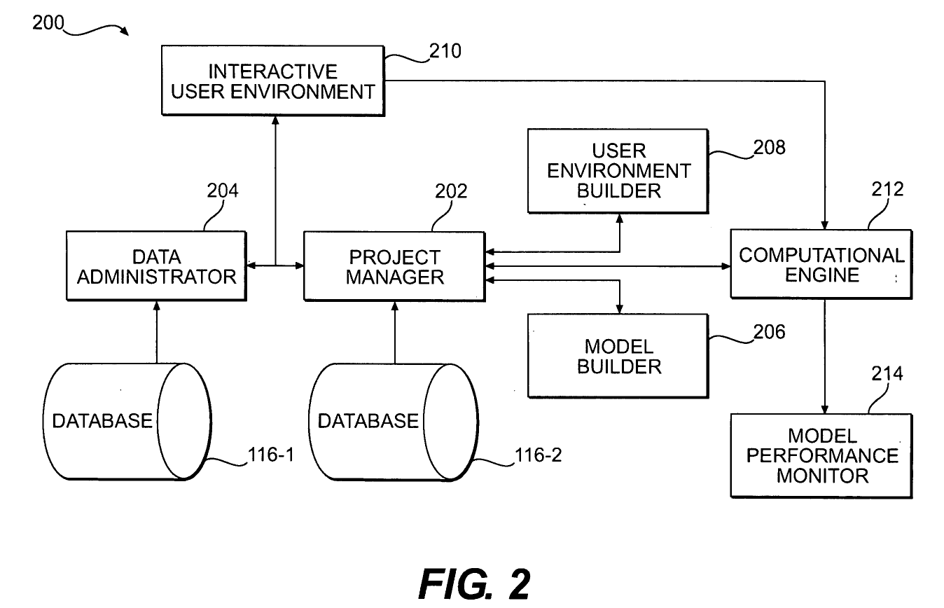

FIG. 2 provides a block diagram representation of a computer architecture 200 representing a flow of information and interconnectivity of various software-based modules that may be included in modeling system 100. Processor 102, and any associated components, may execute sets of instructions for performing the functions associated with one or more of these modules. As illustrated in FIG. 2, these modules may include a project manager 202, a data administrator 204, a model builder 206, a user environment builder 208, an interactive user environment 210, a computational engine 212, and a model performance monitor 214. Each of these modules may be implemented in software designed to operate within a selected operating system. For example, in one embodiment, these modules may be included in one or more applications configured to run in a Windows-based environment.

Modeling system 100 may operate based on models that have been pre-built and stored. For example, in one embodiment, project manager 202 may access database 116-2 to open a stored model project file, which may include the model itself, version information for the model, the data sources for the model, and/or any other information that may be associated with a model. Project manager 202 may include a system for checking in and out of the stored model files. By monitoring the usage of each model file, project manager 202 can minimize the risk of developing parallel, different versions of a single model file.

Alternatively, modeling system 100 may build new models using model builder 206, for example. To build a new model, model builder 206 may interact with data administrator 204, via project manager 202, to obtain data records from database 116-1. These data records may include any data relating to particular input variables and output parameters associated with a system to be modeled. This data may be in the form of manufacturing process data, product design data, product test data, and any other appropriate information. The data records may reflect characteristics of the input parameters and output parameters, such as statistical distributions, normal ranges, and/or tolerances, etc. For each data record, there may be a set of output parameter values that corresponds to a particular set of input variable values.

In addition to data empirically collected through testing of actual products, the data records may include computer-generated data. For example, data records may be generated by identifying an input space of interest. A plurality of sets of random values may be generated for various input variables that fall within the desired input space. These sets of random values may be supplied to at least one simulation algorithm to generate values for one or more output parameters related to the input variables. Each data record may include multiple sets of output parameters corresponding to the randomly generated sets of input parameters.

Once the data records have been obtained, model builder 206 may pre-process the data records. Specifically, the data records may be cleaned to reduce or eliminate obvious errors and/or redundancies. Approximately identical data records and/or data records that are out of a reasonable range may also be removed. After pre-processing the data records, model builder 206 may select proper input parameters by analyzing the data-records.

The data records may include many input variables. In certain situations, for example, where the data records are obtained through experimental observations, the number of input variables may exceed the number of the data records and lead to sparse data scenarios. In these situations, the number of input variables may need to be reduced to create mathematical models within practical computational time limits. In certain other situations, however, where the data records are computer generated using domain specific algorithms, there may be less of a risk that the number of input variables exceeds the number of data records. That is, in these situations, if the number of input variables exceeds the number of data records, more data records may be generated using the domain specific algorithms. Thus, for computer generated data records, the number of data records can be made to exceed, and often far exceed, the number of input variables. For these situations, the input parameters selected by model builder 206 may correspond to the entire set of input variables.

Where the number of input variables exceeds the number of data records, and it would not be practical or cost-effective to generate additional data records, model builder 206 may select input parameters from among the input variables according to predetermined criteria. For example, model builder 206 may choose input parameters by experimentation and/or expert opinions. Alternatively, in certain embodiments, model builder 206 may select input parameters based on a mahalanobis distance between a normal data set and an abnormal data set of the data records. The normal data set and abnormal data set may be defined by model builder 206 by any suitable method. For example, the normal data set may include characteristic data associated with the input parameters that produce desired output parameters. On the other hand, the abnormal data set may include any characteristic data that may be out of tolerance or may need to be avoided. The normal data set and abnormal data set may be predefined by model builder 206.

Mahalanobis distance may refer to a mathematical representation that may be used to measure data profiles based on correlations between parameters in a data set. Mahalanobis distance differs from Euclidean distance in that mahalanobis distance takes into account the correlations of the data set. Mahalanobis distance of a data set X (e.g., a multivariate vector) may be represented as
MDᵢ=(Xᵢ−μₓ)Σ⁻¹(Xᵢ−μₓ)′ (1)
where μₓ is the mean of X and Σ⁻¹ is an inverse variance-covariance matrix of X. MDᵢ weights the distance of a data point Xᵢ from its mean μₓ such that observations that are on the same multivariate normal density contour will have the same distance. Such observations may be used to identify and select correlated parameters from separate data groups having different variances.

Model builder 206 may select a desired subset of input parameters such that the mahalanobis distance between the normal data set and the abnormal data set is maximized or optimized. A genetic algorithm may be used by model builder 206 to search the input parameters for the desired subset with the purpose of maximizing the mahalanobis distance. Model builder 206 may select a candidate subset of the input parameters based on a predetermined criteria and calculate a mahalanobis distance MDₙₒᵣₘₐₗ of the normal data set and a mahalanobis distance MD_{abnormal} of the abnormal data set. Model builder 206 may also calculate the mahalanobis distance between the normal data set and the abnormal data (i.e., the deviation of the mahalanobis distance MDₓ=MDₙₒᵣₘₐₗ−MD_{abnormal}). Other types of deviations, however, may also be used.

Model builder 206 may select the candidate subset of the input parameters if the genetic algorithm converges (i.e., the genetic algorithm finds the maximized or optimized mahalanobis distance between the normal data set and the abnormal data set corresponding to the candidate subset). If the genetic algorithm does not converge, a different candidate subset of the input parameters may be created for further searching. This searching process may continue until the genetic algorithm converges and a desired subset of the input parameters is selected.

After selecting input parameters, model builder 206 may generate a computational model to build interrelationships between the input parameters and output parameters. Any appropriate type of neural network may be used to build the computational model. The type of neural network models used may include back propagation, feed forward models, cascaded neural networks, and/or hybrid neural networks, etc. Particular types or structures of the neural network used may depend on particular applications. Other types of models, such as linear system or non-linear system models, etc., may also be used.

The neural network computational model may be trained by using selected data records. For example, the neural network computational model may include a relationship between output parameters (e.g., engine power, engine efficiency, engine vibration, etc.) and input parameters (e.g., cylinder wall thickness, cylinder wall material, cylinder bore, etc). The neural network computational model may be evaluated by predetermined criteria to determine whether the training is completed. The criteria may include desired ranges of accuracy, time, and/or number of training iterations, etc.

After the neural network has been trained (i.e., the computational model has initially been established based on the predetermined criteria), model builder 206 may statistically validate the computational model. Statistical validation may refer to an analyzing process to compare outputs of the neural network computational model with actual outputs to determine the accuracy of the computational model. Part of the data records may be reserved for use in the validation process. Alternatively, model builder 206 may generate simulation or test data for use in the validation process.

Once trained and validated, the computational model may be used to determine values of output parameters when provided with values of input parameters. Further, model builder 206 may optimize the model by determining desired distributions of the input parameters based on relationships between the input parameters and desired distributions of the output parameters.

Model builder 206 may analyze the relationships between distributions of the input parameters and desired distributions of the output parameters (e.g., design constraints provided to the model that may represent a state of compliance of the product design). Model builder 206 may then run a simulation of the computational model to find statistical distributions for one or more individual input parameters. That is, model builder 206 may separately determine a distribution (e.g., mean, standard variation, etc.) of the individual input parameter corresponding to the normal ranges of the output parameters. Model builder 206 may then analyze and combine the separately obtained desired distributions for all the individual input parameters to determined concurrent desired distributions and characteristics for the input parameters. The concurrent desired distribution may be different from separately obtained distributions.

Alternatively, model builder 206 may identify desired distributions of input parameters simultaneously to maximize the possibility of obtaining desired outcomes (e.g., to maximize the probability that a certain system design is compliant with desired model requirements). In certain embodiments, model builder 206 may simultaneously determine desired distributions of the input parameters based on zeta statistic. Zeta statistic may indicate a relationship between input parameters, their value ranges, and desired outcomes. Zeta statistic may be represented as

$$ζ = {{\sum }_{1}}^{j} {{\sum }_{1}}^{i} \vert {S}_{ij} \vert ( \frac{{σ}_{i}}{{\overline{x}}_{i}} ) ( \frac{{\overline{x}}_{j}}{{σ}_{j}} ) ,$$

where \overline{x}ᵢ represents the mean or expected value of an ith input; \overline{x}ⱼ represents the mean or expected value of a jth outcome; σᵢ represents the standard deviation of the ith input; σⱼ represents the standard deviation of the jth outcome; and |Sᵢⱼ| represents the partial derivative or sensitivity of the jth outcome to the ith input.

Under certain circumstances, \overline{x}ᵢ may be less than or equal to zero. A value of 3 σᵢ may be added to \overline{x}ᵢ to correct such problematic condition. If, however, \overline{x}ᵢ is still equal zero even after adding the value of 3 σᵢ, model builder 206 may determine that σᵢ may be also zero and that the model under optimization may be undesired. In certain embodiments, model builder 206 may set a minimum threshold for σᵢ to ensure reliability of models. Under certain other circumstances, σⱼ may be equal to zero. Model builder 206 may then determine that the model under optimization may be insufficient to reflect output parameters within a certain range of uncertainty. Processor 202 may assign an indefinite large number to ζ.

Model builder 206 may identify a desired distribution of the input parameters such that the zeta statistic of the neural network computational model is maximized or optimized. A genetic algorithm may be used by model builder 206 to search the desired distribution of input parameters with the purpose of maximizing the zeta statistic. Model builder 206 may select a candidate set of input parameters with predetermined search ranges and run a simulation of the model to calculate the zeta statistic parameters based on the input parameters, the output parameters, and the neural network computational model. Model builder 206 may obtain \overline{x}ᵢ and σᵢ by analyzing the candidate set of input parameters, and obtain \overline{x}ⱼ and σⱼ by analyzing the outcomes of the simulation. Further, model builder 206 may obtain |Sᵢⱼ| from the trained neural network as an indication of the impact of ith input on the jth outcome.

Model builder 206 may select the candidate set of input parameters if the genetic algorithm converges (i.e., the genetic algorithm finds the maximized or optimized zeta statistic of the model corresponding to the candidate set of input parameters). If the genetic algorithm does not converge, a different candidate set of input parameters may be created by the genetic algorithm for further searching. This searching process may continue until the genetic algorithm converges and a desired set of the input parameters is identified. Model builder 206 may further determine desired distributions (e.g., mean and standard deviations) of input parameters based on the desired input parameter set. Once the desired distributions are determined, model builder 206 may define a valid input space that may include any input parameter within the desired distributions.

In one embodiment, statistical distributions of certain input parameters may be impossible or impractical to control. For example, an input parameter may be associated with a physical attribute of a device that is constant, or the input parameter may be associated with a constant variable within a model. These input parameters may be used in the zeta statistic calculations to search or identify desired distributions for other input parameters corresponding to constant values and/or statistical distributions of these input parameters.

After the model has been optimized, model builder 206 may define a valid input space representative of an optimized model. This valid input space may represent the nominal values and corresponding statistical distributions for each of the selected input parameters. Selecting values for the input parameters within the valid input space maximizes the probability of achieving a compliance state according to a particular set of requirements provided to the model.

Once the valid input space has been determined, this information, along with the nominal values of the corresponding output parameters and the associated distributions, may be provided to display 110 using interactive user environment 210. This information provided to display 110 represents a view of an optimized design of the probabilistic model.

Interactive user environment 210 may include a graphical interface and may be implemented from one or more stored files or applications that define user environment 210. Alternatively, modeling system 100 may be used to build interactive user environment 210 with user environment builder 208. In environment builder 208, an operator may create one or more customized views for use with any selected version of a probabilistic model built by model builder 206. The operator may create these views using object-based information elements (e.g., graphs, charts, text strings, text boxes, or any other elements useful for conveying and/or receiving information). In this way, information elements may be selected for each version of each probabilistic model such that the probabilistic information associated with these models may be effectively displayed to a user of modeling system 100.

A user of modeling system 100 may use interactive user environment 210 to explore the effects of various changes to one or more input parameters or output parameters associated with a probabilistic model. For example, a user may input these changes via input devices 112. Upon receipt of a change, interactive user environment 210 may forward the changes to computational engine 212. Computational engine 212 may run a statistical simulation of the probabilistic model based on the changes supplied by the user. Based on this simulation, a model output may be generated that includes updates to one or more output parameters and their associated probability distributions that result from the user supplied changes. This model output may be provided to display 110 by interactive user environment 210 such that the user of modeling system 100 can ascertain the impact of the requested parameter changes.

Interactive user environment 210 may be configured for operation across various different platforms and operating systems. In one embodiment, interactive user environment 210 may operate within a browser window that can exchange data with one or more computers or devices associated with uniform resource locators (URLs).

Probabilistic modeling system 100 may include model performance monitor 214 for determining whether meaningful results are being generated by the models associated with modeling system 100. For example, model performance monitor 214 may be equipped with a set of evaluation rules that set forth how to evaluate and/or determine performance characteristics of a particular probabilistic model of modeling system 100. This rule set may include both application domain knowledge-independent rules and application domain knowledge-dependent rules. For example, the rule set may include a time out rule that may be applicable to any type of process model. The time out rule may indicate that a process model should expire after a predetermined time period without being used. A usage history for a particular probabilistic model may be obtained by model performance monitor 214 to determine time periods during which the probabilistic model is not used. The time out rule may be satisfied when the non-usage time exceeds the predetermined time period.

In certain embodiments, an expiration rule may be set to disable the probabilistic model being used. For example, the expiration rule may include a predetermined time period. After the probabilistic model has been in use for the predetermined time period, the expiration rule may be satisfied, and the probabilistic model may be disabled. A user may then check the probabilistic model and may enable process model after checking the validity of the probabilistic model 104. Alternatively, the expiration rule may be satisfied after the probabilistic model made a predetermined number of predictions. The user may also enable the probabilistic model after such expiration.

The rule set may also include an evaluation rule indicating a threshold for divergence between predicted values of model output parameters and actual values of the output parameters based on a system being modeled. The divergence may be determined based on overall actual and predicted values of the output parameters. Alternatively, the divergence may be based on an individual actual output parameter value and a corresponding predicted output parameter value. The threshold may be set according to particular application requirements. When a deviation beyond the threshold occurs between the actual and predicted output parameter values, the evaluation rule may be satisfied indicating a degraded performance state of the probabilistic model.

In certain embodiments, the evaluation rule may also be configured to reflect process variability (e.g., variations of output parameters of the probabilistic model). For example, an occasional divergence may be unrepresentative of a performance degrading, while certain consecutive divergences may indicate a degraded performance of the probabilistic model. Any appropriate type of algorithm may be used to define evaluation rules.

Model performance module 214 may be configured to issue a notification in the case that one or more evaluation rules is satisfied (i.e., an indication of possible model performance degradation). This notification may include any appropriate type of mechanism for supplying information, such as messages, e-mails, visual indicator, and/or sound alarms.

### INDUSTRIAL APPLICABILITY

The disclosed probabilistic modeling system can efficiently provide optimized models for use in modeling any product, component, system, or other entity or function that can be modeled by computer. Using the disclosed system, complex interrelationships may be analyzed during the generation of computational models to optimize the models by identifying distributions of input parameters to the models to obtain desired outputs. The robustness and accuracy of product designs may be significantly improved by using the disclosed probabilistic modeling system.

Unlike traditional modeling systems, the disclosed probabilistic modeling system effectively captures and describes the complex interrelationships between input parameters and output parameters in a system. For example, the disclosed zeta statistic approach can yield knowledge of how variation in the input parameters translates to variation in the output parameters. This knowledge can enable a user interacting with the disclosed modeling system to more effectively and efficiently make design decisions based on the information supplied by the probabilistic modeling system.

Further, by providing an optimized design in the form of a probabilistic model (e.g., probability distributions for each of a set of input parameters and for each of a set of output parameters), the disclosed modeling system provides more information than traditional modeling systems. The disclosed probabilistic modeling system can effectively convey to a designer the effects of varying an input parameter over a range of values (e.g., where a particular dimension of a part varies over a certain tolerance range). Moreover, rather than simply providing an output indicative of whether or not a compliance state is achieved by a design, the disclosed system can convey to the designer the probability that a particular compliance state is achieved.

The interactive user environment of the disclosed probabilistic modeling system can enable a designer to explore “what if” scenarios based on an optimized model. Because the interrelationships between input parameters and output parameters are known and understood by the model, the designer can generate alternative designs based on the optimized model to determine how one or more individual changes will affect, for example, the probability of compliance of a modeled part or system. While these design alternatives may move away from the optimized solution, this feature of the modeling system can enable a designer to adjust a design based on his or her own experience. Specifically, the designer may recognize areas in the optimized model where certain manufacturing constraints may be relaxed to provide a cost savings, for example. By exploring the effect of the alternative design on compliance probability, the designer can determine whether the potential cost savings of the alternative design would outweigh a potential reduction in probability of compliance.

Other embodiments, features, aspects, and principles of the disclosed exemplary systems will be apparent to those skilled in the art and may be implemented in various environments and systems.

What is claimed is:

1. A computer system for probabilistic modeling, comprising:
a display;
one or more input devices; and
a processor configured to execute instructions for:
generating at least one view representative of a probabilistic model;
providing the at least one view to the display;
receiving data through the one or more input devices;
running a simulation of the probabilistic model based on the data;
generating a model output including a predicted probability distribution associated with each of one or more output parameters of the probabilistic model; and
providing the model output to the display.

2. The computer system of claim 1, wherein the data includes a probability distribution associated with at least one input parameter to the probabilistic model.

3. The computer system of claim 1, wherein the probabilistic model represents interrelationships between one or more input parameters to the probabilistic model and the one or more output parameters, and the predicted probability distribution associated with the one or more output parameters represents a probability of compliance with a desired set of model requirements.

4. The computer system of claim 1, wherein the processor is further configured to execute instructions for:
obtaining information relating to actual values for the one or more output parameters;
determining whether a divergence exists between the actual values and the predicted probability distribution associated with the one or more output parameters; and
issuing a notification if the divergence is beyond a predetermined threshold.

5. The computer system of claim 1, wherein the at least one view is included on the display in a browser window.

6. The computer system of claim 1, wherein the model output is included on the display in a browser window.

7. A computer system for building a probabilistic model, comprising:
at least one database;
a display; and
a processor configured to execute instructions for:
obtaining, from the at least one database, data records relating to one or more input variables and one or more output parameters;
selecting one or more input parameters from the one or more input variables;
generating, based on the data records, the probabilistic model indicative of interrelationships between the one or more input parameters and the one or more output parameters, wherein the probabilistic model is configured to generate statistical distributions for the one or more input parameters and the one or more output parameters, based on a set of model constraints; and
displaying at least one view to the display representative of the probabilistic model.

8. The computer system of claim 7, wherein the at least one view is included in a browser window.

9. The computer system of claim 7, including:
at least one input device, and
wherein the processor is further configured to execute instructions for:
receiving data through the at least one input device;
running a simulation of the probabilistic model based on the data;
generating a model output including a predicted probability distribution associated with each of the one or more output parameters; and
providing the model output to the display.

10. The computer system of claim 7, wherein the processor is further configured to execute instructions for:
constructing the at least one view based on a selected version of the probabilistic model and one or more object-based information elements selected for inclusion in the at least one view.

11. The computer system of claim 7, wherein the selecting further includes:
pre-processing the data records; and
using a genetic algorithm to select the one or more input parameters from the one or more input variables based on a mahalanobis distance between a normal data set and an abnormal data set of the data records.

12. The computer system of claim 7, wherein generating the probabilistic model includes:
creating a neural network computational model;
training the neural network computational model using the data records; and
validating the neural network computation model using the data records.

13. The computer system of claim 7, wherein the probabilistic model is configured to generate to generate the statistical distributions by:
determining a candidate set of input parameters with a maximum zeta statistic using a genetic algorithm; and
determining the statistical distributions of the one or more input parameters based on the candidate set,
wherein the zeta statistic ζ is represented by:
$$ζ = {{\sum }_{1}}^{j} {{\sum }_{1}}^{i} \vert {S}_{ij} \vert ( \frac{{σ}_{i}}{{\overline{x}}_{i}} ) ( \frac{{\overline{x}}_{j}}{{σ}_{j}} ) ,$$
provided that \overline{x}ᵢ represents a mean of an ith input; \overline{x}ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

14. A computer readable medium including instructions for:
displaying at least one view representative of a probabilistic model, wherein the probabilistic model is configured to represent interrelationships between one or more input parameters and one or more output parameters and to generate statistical distributions for the one or more input parameters and the one or more output parameters, based on a set of model constraints;
receiving data through at least one input device;
running a simulation of the probabilistic model based on the data;
generating a model output including a predicted probability distribution associated with each of the one or more output parameters; and
providing the model output to a display.

15. The computer readable medium of claim 14, wherein the model output is included in a browser window.

16. The computer readable medium of claim 14, further including instructions for building the probabilistic model including:
obtaining, from at least one database, data records relating to one or more input variables and one or more output parameters;
selecting the one or more input parameters from the one or more input variables; and
generating the probabilistic model based on the data records.

17. The computer readable medium of claim 16, wherein the generating includes:
creating a neural network computational model;
training the neural network computational model using the data records; and
validating the neural network computation model using the data records.

18. The computer readable medium of claim 16, wherein the selecting further includes:
pre-processing the data records; and
using a genetic algorithm to select the one or more input parameters from the one or more input variables based on a mahalanobis distance between a normal data set and an abnormal data set of the data records.

19. The computer readable medium of claim 14, wherein the probabilistic model is configured to generate the statistical distributions by:
determining a candidate set of input parameters with a maximum zeta statistic using a genetic algorithm; and
determining the statistical distributions of the one or more input parameters based on the candidate set,
wherein the zeta statistic ζ is represented by:
$$ζ = {{\sum }_{1}}^{j} {{\sum }_{1}}^{i} \vert {S}_{ij} \vert ( \frac{{σ}_{i}}{{\overline{x}}_{i}} ) ( \frac{{\overline{x}}_{j}}{{σ}_{j}} ) ,$$
provided that \overline{x}ᵢ represents a mean of an ith input; \overline{x}ⱼ represents a mean of a jth output; σᵢ represents a standard deviation of the ith input; σⱼ represents a standard deviation of the jth output; and |Sᵢⱼ| represents sensitivity of the jth output to the ith input of the computational model.

20. The computer readable medium of claim 14, further including instructions for:
constructing the at least one view based on a selected version of the probabilistic model and one or more object based information elements selected for inclusion in the at least one view.

21. The computer readable medium of claim 14, further including instructions for
obtaining information relating to actual values for the one or more output parameters;
determining whether a divergence exists between the actual values and the predicted probability distribution associated with the one or more output parameters; and
issuing a notification if the divergence is beyond a predetermined threshold.
